(19) United States
(12) Patent Application Publication
(10) Pub. No.: US 2025/0013875 A1
(43) Pub. Date: Jan. 9, 2025

(54) SYSTEM AND METHOD FOR AUTONOMOUS VEHICLE MOTION PLANNER OPTIMISATION

(71) Applicant: HUAWEI TECHNOLOGIES CO., LTD., Shenzhen (CN)

(72) Inventors: Alexander Imani Cowen-Rivers, London (GB); Yilun Yang, Shanghai (CN); Shaoyu Yang, Beijing (CN); Rasul Tutunov, London (GB); Aivar Sootla, London (GB); Haitham Bou Ammar, London (GB); Hongbo Zhang, Shenzhen (CN)

(21) Appl. No.: 18/885,379

(22) Filed: Sep. 13, 2024

Related U.S. Application Data
(63) Continuation of application No. PCT/CN2022/080910, filed on Mar. 15, 2022.

(51) Int. Cl. G06N 3/0985; B60W 60/00; G06N 3/045; G06N 7/01

(52) U.S. Cl. CPC G06N 3/0985; B60W 60/001; G06N 3/045; G06N 7/01

(57) ABSTRACT

An apparatus is provided for determining improved motion planner hyperparameters. The apparatus is configured to: receive a data pair comprising a set of hyperparameters and a utility score defining a utility of a motion planner outcome resulting from the set of hyperparameters; provide a model defining a relationship between the hyperparameters and the utility score; generate trial hyperparameters using a guidance objective configured to evaluate a quality of trial sets of hyperparameters in dependence on the model; determine a trial outcome of the motion planner based on the trial hyperparameters; and determine a new utility score of the trial hyperparameters based on comparing the trial outcome with truth data. The apparatus therefore optimises currently deployed hyperparameters by comparison with truth data in order to provide hyperparameters that can produce realistic motion planning trajectories and outperform currently deployed hyperparameters.

### CROSS-REFERENCE TO RELATED APPLICATIONS

This application is a continuation of International Application No. PCT/CN2022/080910, filed on Mar. 15, 2022, the disclosure of which is hereby incorporated by reference in its entirety.

### FIELD OF THE INVENTION

Embodiments of this disclosure relate to finding improved hyperparameters for use in an autonomous vehicle motion planner, in particular using machine learning methods such as Bayesian optimisation and/or evolutionary algorithms.

### BACKGROUND

The objective of a reliable autonomous driving vehicle (ADV) is to make realistic and safe decisions for controlling the motion of a vehicle, with or without real-time user input. These decisions are controlled by a motion planner within the ADV. An optimal motion planner, however, is designed to output human-like decisions for all motions of the car. Therefore, a well-designed motion planner should be designed not only with hard constraints such as collision avoidance of road users, obstacles, and pedestrians, but also such that its output mimics the driving style of a human. However, implementing a motion planner in this way is highly non-trivial.

The first challenge is to design a suitable architecture for a motion planner that is capable of assimilating a vast amount of information obtained from the ADV's surroundings and processing that information to generate suitable motion planning decisions. A second challenge is how to train and/or operate a motion planner, having already designed the motion planner architecture, such that the motion planner makes the most effective use of the input information to generate accurate decisions.

This disclosure generally pertains to the second challenge. It is known in the art that motion planners use weights, or hyperparameters, which influence how the motion planner processes the information from its surroundings. However, selecting or designing the best set of hyperparameters for a motion planner is difficult because the relationship between hyperparameters and motion output is so complex that it is generally unknowable. Therefore, it is generally impossible to analytically determine the ‘best’ set of hyperparameters a given most motion planners. For example, motion planners typically utilise many hundreds or thousands of hyperparameters, whose values can be integers, continuous variables, categorical variables, Boolean values, etc. Additionally, the motion planner algorithms are often complex and computationally expensive to repeatedly run during training. Consequently, even with a good-quality set of a human-labelled decisions with which to determine optimal hyperparameters, the task of how to select the best hyperparameters for deployment of a motion planner remains challenging.

Furthermore, it is difficult to select for a set of hyperparameters that can generalise to new locations. In other words, the chosen hyperparameters should not be ‘overfit’, i.e., they should produce accurate and safe decisions in a variety of places and scenarios, and not just for the types of places/scenarios used in the data that trained the motion planner.

As a consequence of these difficulties, it is typical for motion planner hyperparameters to be tuned by a human. Nevertheless, several related methods of improving the performance of automounts driving vehicles are known in the art.

In US 2020/0150671, a system is disclosed which generates and scores trajectories based on a reward function that utilises inverse reinforcement learning. The highest rewarded trajectory is then selected to control the ADV. However, multiple different trajectories are determined before a ‘best’ one is selected. This disclosure does not disclose tuning parameters of a motion planner directly.

In WO 2020/056331 A1, a system is disclosed for collecting training data, in which training data is collecting from a real ADV, and a neural network classifier is used to determine whether the training data is of good enough quality. This disclosure does not disclose how to train hyperparameters and does not disclose using human-labelled decision data which is inherently deemed correct.

In CN 105946858A, a genetic algorithm is disclosed which adjusts the parameters for the estimation models used to predict important properties such as estimating longitudinal tire force, which is used for downstream control methods. This disclosure does not disclose tuning the parameters of a sampler which weights which trajectory to select based on the trajectory with the lowest cost.

In CN108216250A, a system is disclosed for adaptively changing ADV parameters based on passengers' immediate feedback using a machine learning model to adjust the parameters. This disclosure therefore relates to real-time adjustment of parameters during and after deployment and does not disclose tuning and selecting all hyperparameters before ADV deployment.

In “Hyperparameter Optimization in Black-box Image Processing using Differentiable Proxies, published at ACM SIGGRAPH 2019”: optimisation of an image processing component of an ADV system is disclosed. This therefore relates to optimisation of processing the input information, however, does not disclose optimising a system that weighs different trajectories for vehicle control, in which the image processing component remain unchanged.

In “Hyperparameter Optimization using Grid Search for use in Monocular Depth Estimation, in CAT Vehicle 2020 Technical Reports, 2020”, the tuning of hyperparameters for a depth estimation model is disclosed. Therefore, this relates to the tuning of a specific subset of hyperparameters and does not disclose generally tuning all hyperparameters for a motion planning system that.

“Simple and Scalable Predictive Uncertainty Estimation using Deep Ensembles—NIPS 2017” discloses methods of quantifying predictive uncertainty in deep neural networks.

In “Hyperband: A Nobel Bandit Based Approach to Hyper parameter Optimization—JMLR 2018: Focus on a different problem”, multi-fidelity hyper parameter optimisation of large machine learning models is disclosed, in which the training process may be temporarily halted to modify parameters.

It would be advantageous to an efficient solution for selecting optimised hyperparameters for ADV motion planners that outperform the next-best human-selected hyperparameters currently in deployment. It would also be advantageous to provide hyperparameters that are generalisable to unknown locations and scenarios.

### SUMMARY

According to a first aspect, an apparatus is provided for determining improved hyperparameters for use in an autonomous vehicle motion planner, the apparatus comprising one or more processors and a memory storing data in non-transient form defining program code executable by the one or more processors to determine the improved hyperparameters. The apparatus is configured to: receive data comprising at least one data pair, each data pair comprising a set of hyperparameters and a utility score defining a utility of a motion planner outcome resulting from the set of hyperparameters; provide a model, based on the at least one data pair, defining a relationship between the set of hyperparameters and the corresponding utility score; generate at least one trial set of hyperparameters using a guidance objective configured to evaluate a quality of trial sets of hyperparameters in dependence on the model; determine a trial outcome of the motion planner in dependence on the trial set of hyperparameters and predetermined journey data; determine a new utility score of the trial set of hyperparameters, wherein the new utility score is determined in dependence on a comparison of the trial outcome with truth outcome data associated with the predetermined journey data; and generate a new data pair comprising the trial set of hyperparameters and the new utility score.

Advantageously, by building the model based on existing hyperparameter data (for example, hyperparameters used in currently deployed autonomous vehicles), and by calculating the new utility score for trial hyperparameters in dependence on truth outcome data (e.g., human-labelled decisions), new sets of hyperparameters can be generated which outperform current hyperparameters, and additionally which are able to operate a motion planner such that it produces realistic results consistent with a human driving style. This is beneficial for safely integrating an autonomous driving vehicle (ADV) into a real-world traffic environment. Furthermore, by generating trial hyperparameters based on a model that is scored in dependence on predetermined journey data (which, preferably, is real driving data obtained from real roads, and further preferably contains a variety of environments), the improved hyperparameters can be advantageously applied to new and unknown scenarios that did not necessarily form part of the predetermined journey data.

In some implementations, the model may be a probabilistic surrogate function, and wherein the guidance objective is configured to generate the at least one trial set of hyperparameters by: fitting the probabilistic surrogate function to one or more of the at least one data pair; and searching a domain space of hyperparameter inputs in dependence on sampling the probabilistic surrogate function. Advantageously, a probabilistic surrogate model is able to guide the search for trial hyperparameters efficiently, because such a surrogate model is, in general, much less time-intensive to run than a static or dynamic motion planner. Furthermore, a probabilistic surrogate function is able to guide the search for trial hyperparameters based on determining a predictive uncertainty of new data points (e.g., hyperparameter sets).

In some implementations, the probabilistic surrogate function may be a gaussian process model, and in other implementations the probabilistic surrogate function may be a gaussian mixture model formed from the combination of a plurality of neural networks. A gaussian process has the advantage of being very flexible, and applicable even to complex functions such as motion planners. Furthermore, gaussian processes can be readily initialised based on only one data pair, and used to generate more data pairs on subsequent iterations. A gaussian mixture model (GMM) formed from the combination of a plurality of neural networks provides the advantage that even very noisy and/or complex functions can be modelled, i.e., such that effective exploration and exploitation of the surrogate function can be carried out.

In some implementations, the search of the domain space of hyperparameter inputs is guided by an acquisition function configured to calculate the quality of trial sets of hyperparameters based at least in part on a predicted uncertainty of a value of the surrogate function resulting from a trial set of hyperparameters. This has the benefit that the perceived value of a trial set of hyperparameters (i.e., as calculated by the model) can be offset against a predicted uncertainty of that value. Therefore, acquisition functions have the advantage of tunability, e.g., such that a trade-off can be determined between effective exploration and exploitation such that global maxima or global minima of the surrogate function can be determined.

In some implementations, the acquisition function comprises one or more of the following functions: an expected utility function, a probability of improvement function, and an upper confidence bound function. These functions can readily be employed alone, or in combination, and moreover are easily tradeable or interchangeable throughout the course of the process carried out by the apparatus.

In some implementations the search of the domain space of hyperparameter inputs is guided by an evolutionary algorithm. For example, the search for trial sets of hyperparameters using acquisition functions can itself be guided by an evolutionary algorithm. In other examples, gradient based methods may be used to direct the search for trial hyperparameters using the acquisition functions.

In some implementations, the model is the motion planner, and the guidance objective is configured to generate the at least one trial set of hyperparameters using an evolutionary algorithm to stochastically determine new data pairs in dependence on evaluating a utility score of one or more new sets of hyperparameters. In other words, the model may be a motion planner itself (preferably a static motion planner) and not a surrogate function or approximation to the motion planner. In particular, some examples may employ sample a motion planner directly, e.g., when the computational cost of a motion planner is not prohibitively high. Embodiments where the model is a motion planner have the advantage that the quality of trial hyperparameters determined by the model and/or the guidance objective are accurate, i.e., because the motion does not approximate the relationship between hyperparameters and the corresponding utility score, and instead calculates it directly. Consequently, an evolutionary algorithm can efficiently converge on improved hyperparameters by directly querying the motion planner.

In some implementations, the trial outcome is a vehicle trajectory comprising a plurality of vehicle motion decisions corresponding to at least one type of vehicle motion action. For example, the vehicle motion action may be a speed change such as acceleration or braking, lateral planning decisions such as steering or lane change, indicating, and the like.

In some implementations, the utility score represents the accuracy of a trial outcome compared to the truth outcome data, the truth outcome data comprising human-labelled vehicle motion decisions. Advantageously, using human-labelled decisions enables the process to provide trial hyperparameters which, when used to operate a motion planner, provide more realistic driving decisions (e.g., decisions which mimic human decisions). Human-labelled decisions therefore have the benefit that hyperparameters which outperform currently-deployed hyperparameters are more likely to be found.

In some implementations the utility score is calculated in dependence on an objective function which rewards correct decisions in the trial outcome and/or penalises decisions in the trial outcome which are incorrect, and which have previously been determined correctly based on an initial set of hyperparameter inputs in the received data. The inventors have identified that it can be beneficial to heavily penalised sets of hyperparameters that produce incorrect decisions where those same decisions were decided correctly by currently deployed hyperparameters. Providing this metric into the utility score calculation helps encourage the generation of improved hyperparameters, and discourages returning trial hyperparameters that do not perform well. In other words, a utility score defined in this way has the advantage that generated trial hyperparameters should be at least as good as those in the received data.

In some implementations, the predetermined journey data comprises a plurality of journeys, and the apparatus is further configured to: determine a plurality of trial outcomes, one per journey, using the trial set of hyperparameters; and determine the utility score based on the plurality of trial outcomes. For example, the predetermined journey data may contain data from real journey carried out at a range of different cities and in arrange of different traffic conditions and driving environments. Using predetermined journey data that comprises a plurality of journeys carries the advantage that generated hyperparameters generalise well to unknown environments.

In some implementations, the apparatus is configured to determine the trial outcome of the motion planner using a static simulator. Static simulators still provide realistic trial outcome results, however, are more efficient to run than dynamic simulators.

In some implementations, the apparatus is further configured to iterate the steps of generating at least one trial set of hyperparameters and determining a new utility score, wherein the received data comprises a previously generated new data pair. In this way, the apparatus is configured to build upon the data so that subsequent iterations can produce more valuable trial sets of hyperparameters. Advantageously, the model can produce higher quality trial hyperparameters after subsequent iterations because the received data contains more information on which to base the model. Further advantageously, the quality of the sets of hyperparameters in the received data is not relevant for generating good quality hyperparameters, because each set of hyperparameters has an associated score which indicates how good or bad each hyperparameter set is. Therefore, the model inherently encodes in the relationship how to determine good trial hyperparameters and how to avoid generating lesser quality trial hyperparameters.

According to another aspect of the present disclosure, a method is provided for determining improved hyperparameters for use in an autonomous vehicle motion planner. The method comprises: receiving data comprising at least one data pair, each data pair comprising a set of hyperparameters and a utility score defining a utility of a motion planner outcome resulting from the set of hyperparameters; providing a model, based on the at least one data pair, defining a relationship between the set of hyperparameters and the corresponding utility score; generating at least one trial set of hyperparameters using a guidance objective configured to evaluate a quality of trial sets of hyperparameters in dependence on the model; determining a trial outcome of the motion planner based on the trial set of set of hyperparameters and predetermined journey data; determining a new utility score of the trial set of hyperparameters, wherein the new utility score is determined in dependence on a comparison of the trial outcome with truth outcome data of the predetermined journey data; and generating a new data pair comprising the trial set of hyperparameters and the new utility score.

### BRIEF DESCRIPTION OF THE DRAWINGS

The present disclosure is described by way of example, with reference to the accompanying drawings, in which:

FIG. 1 shows a representation of environmental inputs used by an autonomous vehicle during a journey;

FIG. 2 shows a diagram representing the architecture of control system for an autonomous driving vehicle;

FIGS. 3a and 3b each outline an iterative process carried out to generate improved hyperparameters inputs where the motion planner is considered a black box;

FIG. 4 shows a more detailed iterative process, relative to FIGS. 3a and 3b, carried out to generate improved hyperparameters inputs where the motion planner is considered a black box;

FIG. 5 illustrates part of the iterative process shown in FIG. 4, in examples where the solver uses Bayesian optimisation;

FIG. 6 illustrates two pathways for carrying out the sampling process using Bayesian optimisation;

FIG. 7 shows an example method of the present disclosure for directly sampling the motion planner using an evolutionary algorithm, and some example results of running the algorithm;

FIG. 8 illustrates an example of part of the iterative process of FIG. 4 in which a quality of the motion planner outputs, generated using a set of improved hyperparameters inputs, is calculated;

FIG. 9 illustrates an example of an apparatus configured to perform the methods described herein;

FIG. 10 shows an example method of the present disclosure for providing improved hyperparameters for use in an autonomous vehicle motion planner;

FIGS. 11a and 11b show graphs illustrating the results of a dynamic autonomous driving simulation test, carried out using improved hyperparameters generated using methods of the present disclosure.

### DETAILED DESCRIPTION

This disclosure concerns an apparatus and method for determining improved sets of hyperparameters, or weights, for use in operating a motion planner of an autonomous driving vehicle (ADV).

Embodiments of the present disclosure are directed at solving the aforementioned problems by searching for hyperparameters that outperform the hyperparameters in currently-deployed ADVs, e.g., where currently-deployed hyperparameters may be partially or entirely manually selected/tuned. In this context, ‘outperform’ should be understood as meaning that the results of a motion planner (operated by an improved set of hyperparameters) contain a trajectory that safer, and/or more accurate and/or contains more decisions that are deemed correct. For example, trajectories can be compared to a set of trajectory decisions that have been human-labelled such that they can be considered ‘ground truth’ data.

Embodiments of the present method use algorithms such as Bayesian optimisation or evolutionary algorithms, either alone or in combination, to sample the vast domain space of hyperparameter inputs in order to find an improved set of hyperparameters. In examples, the complexity of the motion planner itself makes it prohibitively expensive to repeatedly run (from a compute-time perspective). Therefore, embodiments of the method simulate the results of the motion planner using surrogate functions which are modelled on the motion planner. The surrogate functions are subsequently sampled in order to obtain improved sets of hyperparameters. In this way, the computationally-expensive motion planner can be run only once per iteration (at most) in order to test the accuracy/quality of a new set of hyperparameters. In other examples, evolutionary algorithms can be used to sample the results of a motion planner directly, where the best set of hyperparameters are used as a basis from which to spawn new set of hyperparameters. The quality and/or utility of new sets of hyperparameters can be objectively quantified using a suitable objective function, e.g., cost or reward function, which compares the output produced by the operation of the motion planner using the trial hyperparameters against human-labelled data (i.e., ground truth data) that is deemed to be correct.

Therefore, the present disclosure achieves the result of providing improved hyperparameters that outperform the current best, and doing so in a time-efficient manner, by sampling the results of a motion planner and comparing trial sets of hyperparameters to ‘ground truth’ trajectory data. A further advantage of obtaining hyperparameters that allow a motion planner to generate human-like decisions is that the movements of an ADV are easier for other humans to predict, thereby allowing better integration of ADVs into human-occupied roads.

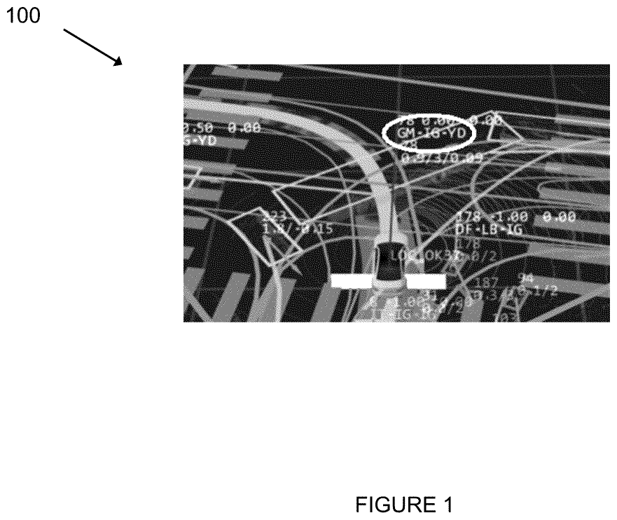

FIG. 1 illustrates a computer rendering 100 of an autonomous vehicle during a journey, showing a plurality of environmental conditions and objects. The data shown in this image 100 represents a fraction of the input that an autonomous vehicle uses to guide the motion planner. A set of hyperparameters is used by the motion planner of an ADV to indicate the relative importance of each environmental factor in the data obtained by the ADV in order to make motion decisions. A motion planner may contain hundreds or even thousands of hyperparameters. Not all hyperparameters are independent, e.g., there may exist some degeneracy or overlap in which two hyperparameters encode similar things. Different hyperparameters are used by motion planners to influence different types of decisions, however, some hyperparameters are shared, i.e., influence multiple different (or all) decisions made by the ADV.

Embodiments of this disclosure aim to simulate the motion planner's decisions according to recorded real-world scenarios and improve the hyperparameters/weights used to operate the motion planner such that the decisions output by the motion planner mimic expert (human) decisions. Preferably, a static simulator is used by the motion planner as part of this process, however, in other embodiments a more realistic dynamic simulator may be used.

Thus, it is advantageous for the safe operation of an ADV that the hyperparameters be chosen accurately, and preferably such that the motion planner generates a trajectory that is comparable to the driving style of a human.

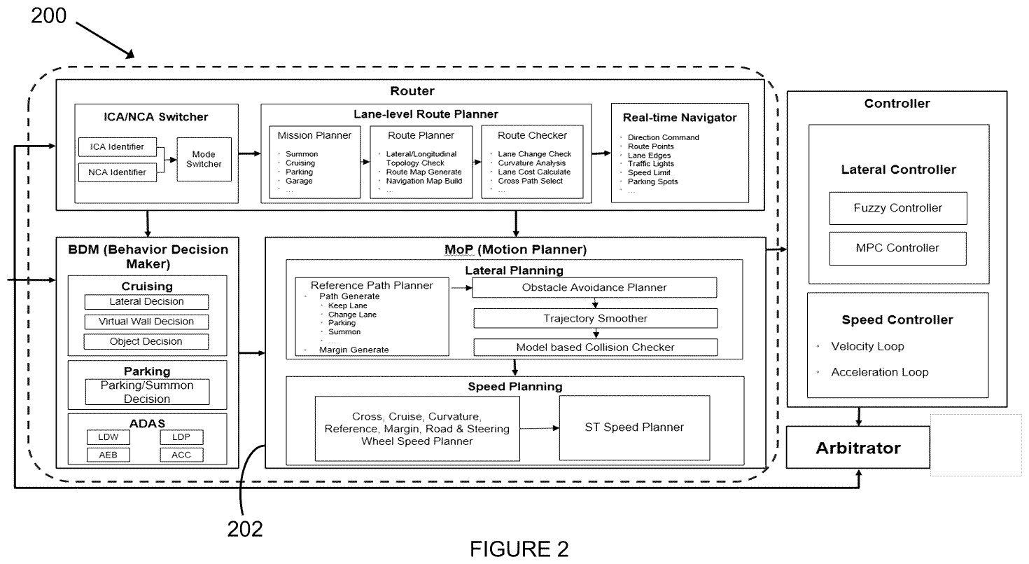

FIG. 2 illustrates an architecture of a computing system 200 that controls an ADV and shows where the motion planner 202 is implemented in the context of this system 200. The motion planner control various aspects of a car's movements, e.g., lateral planning which involves obstacle avoidance and lane selection or cut-in, and longitudinal planning which pertains to vehicle acceleration and braking. In general, there are four types of motions/trajectories controlled by a motion planner:

General movements: i.e., involving all interactions with the ADV's environment.
1. Lateral: generally, decisions involving steering, e.g., decisions involving when to change lanes (cut-in), obstacle avoidance, lane discipline, and the like.
2. Longitudinal: generally, movements involving acceleration (i.e., use of the throttle) and deceleration (e.g., using the brake), such as deciding when to give way to another vehicle at an intersection.
3. Speed planning: planning a speed profile for the ADV to follow.

Throughout this disclosure, the algorithm of the motion planner itself is pre-determined; this disclosure is aimed at methods of tuning the hyperparameters which influence how motion planner operates. Thus, the type of algorithm or architecture of the motion planner is not relevant. Indeed, in embodiments of the present disclosure, the motion planner is treated as a black box whose precise functionality is unknown, where the hyperparameters used to operate the motion planner are selected to optimise an output of the motion planner.

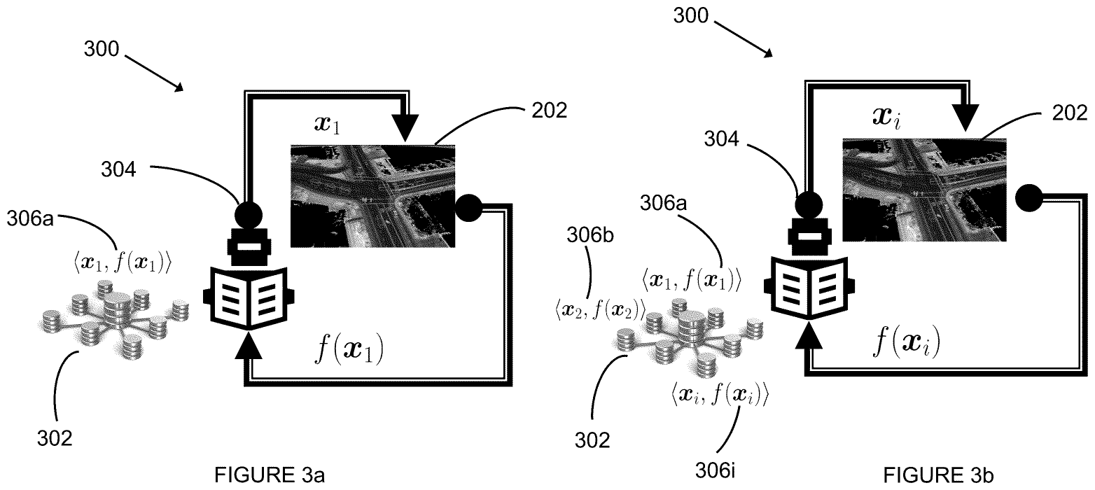

FIGS. 3a and 3b illustrates such an example, i.e., where an iterative process 300 is carried out to generate improved hyperparameters inputs, and where the motion planner 202 is considered a black box. FIG. 3a shows the first step of a process 300 to generate improved hyperparameters inputs, where the process begins with only one data point, x₁. FIG. 3b illustrates step i of the iterative process in general, where the initial set of data comprises i pairs of data.

In FIG. 3a, the first data point, x₁, represents an initial set of hyperparameters. Preferably, the first data point, x₁, comprises the set of hyperparameters used in currently deployed ADVs, or otherwise contains a set of hyperparameters that has been validated (e.g., by a human expert) such that it is known to produce good results.

The initial input data, x₁, is used as an input for a motion planner 202. This planner 202 is considered a black box whose functional/analytical form is not known. Preferably, the motion planner used is a static simulator, which is run using real, predetermined, journey data. Preferably, multiple different journeys are used to calculate the result of the input, such that the improved set of hyperparameters will generalise more effectively ton unknown locations. The motion planner 202 ultimately quantifies the quality of the hyperparameter input, to generate a first data pair 306a, [symbol] x₁, f (x₁) [symbol] . Preferably, the quality of the hyperparameter input is represented as a cost, f (x₁). This data pair forms part of the data 302 which is iteratively generated each step.

At any given iteration, the existing data 302, containing all known data pairs 306a . . . 306i, is provided to an agent 304. The agent 304 represents some model which searches the domain space of hyperparameters inputs and generates a trial set of hyperparameters, i.e., hyperparameters that are predicted to provide an improved result for the motion planner. The agent 304 utilises a guidance objective to help the search for a set of trial hyperparameters, where the guidance objective is based on the existing set of data (e.g., [symbol] x₁, f (x₁) [symbol] in the first iteration). In a second iteration of the process, the agent 304 generates a trial set of hyperparameters, x₂, which is fed into the motion planner 202. A second data pair 306b, [symbol] x₂, f (x₂) [symbol] is then used by the agent, together with the first data pair, to provide a further trial set of hyperparameters.

In examples where the computational cost of the motion planner 202 is high, it is advantageous to avoid running the motion planner. Therefore, preferably, the agent 304 uses a simulated model of the motion planner (such as a surrogate function when using Bayesian optimisation) to generate trial sets of hyperparameters. In other examples, the agent may use the motion planner algorithm itself to calculate the quality of trial sets of hyperparameters xᵢ (e.g., as part of an evolutionary algorithm).

To calculate the cost, f(xᵢ), of a given set of hyperparameters, the motion planner first generates a motion planning output, i.e., a trajectory or set of decisions, from which the cost can be calculated. Preferably, the cost function utilises a set of human-labelled decisions based on the same predetermined journey data against which to validate the trial hyperparameters. The human-labelled decisions are thus deemed ground truth data, or truth outcome data.

An example of a reward function used to validate the utility of a trial set of hyperparameters against human-labelled decisions is as follows:

$$Cost ( θ ) = \sum {[ {\sum }_{i} max ( l [ {d}_{i , j}^{θ} \neq ] , λ * I [ {d}_{i , j}^{θ} \neq ] * I [ \overline{{d}_{i , j}} = ] ) ]}_{j}$$

where
d_{i,j}^{θ}=Decision i for scenario j from MOP planner with tuned parameters θ;
[symbol] =Decision i for scenario j from MOP planner with default parameters;
[symbol] =Correct decision i for scenario j from human;
I[·]=Return 1 if statement inside is true; else 0 if false; and
λ=an importance weighting.

In particular, the value of λ is chosen to help influence the hyperparameter selection algorithm to preserve previously correct decisions. The inventors have identified that it is advantageous to provide a cost function which not only places a positive emphasis on correct decisions, but strongly penalizes decisions which were correct using the default parameters, [symbol] , but which have been incorrectly determined (d_{i,j}^{θ}) using the trial set of hyperparameters. In other words, the search for good quality hyperparameters is improved by placing a strong de-emphasis on hyperparameters which produce worse results than the currently deployed hyperparameters. Thus, λ is chosen to have a value greater than 1 to provide this de-emphasis on newly incorrect decisions, e.g., where λ=1.5 or 2.

It will therefore be apparent to the skilled person that the nature of the cost function, as well as the functional form of the motion planner 202, has an influence on the generation of new data pairs, [symbol] xᵢ, f(xᵢ) [symbol] , and thus affects the efficiency with which improved hyperparameters can be determined. Thus, in some embodiments, different forms of the cost function are used. Providing different forms of cost function would be within the remit of the skilled person. In some examples, the functional form of the cost function may be changed during the course of the process 300.

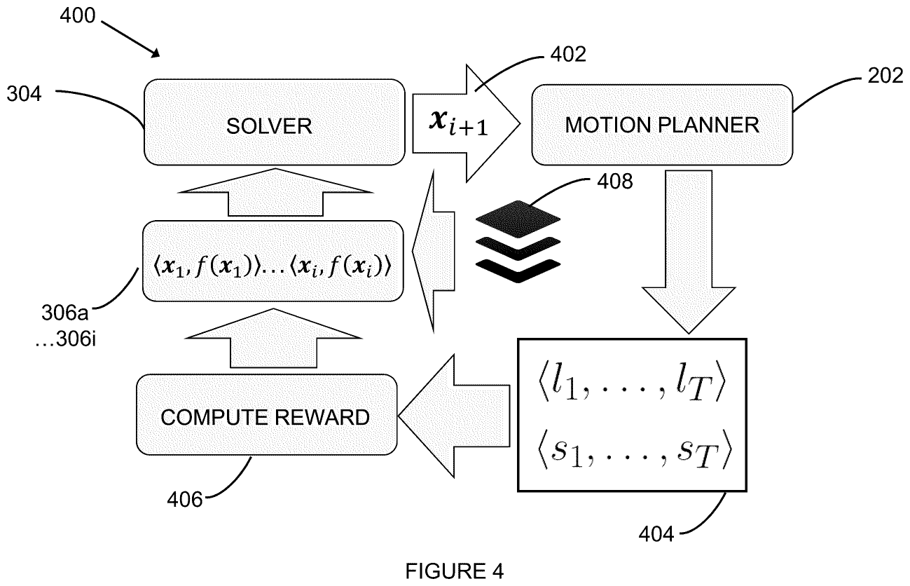

FIG. 4 illustrates the same iterative process 400 as in FIGS. 3a and 3b in greater detail, again where motion planner 202 is considered a black box whose functional form is unknown.

A set of data pairs 306a . . . 306i, [symbol] x₁, f(x₁) [symbol] , [symbol] x₂, f(x₂) [symbol] . . . [symbol] xᵢ, f(xᵢ) [symbol] , represents the starting data. Initially, this data is obtained from a data store 408 which may, e.g., contain data relating to currently deployed ADVs. Preferably, one of the data pairs contains a set of hyperparameters, x_{I}, that represents currently deployed hyperparameters. The data is passed onto a solver 304 (also known as the ‘agent’, e.g., agent 304 in FIG. 3), which generates a trial search point 402, xᵢ₊₁, based at least on the existing data (306a . . . 306i) and some form of guidance objective. The guidance objective uses the known sets of hyperparameters, and their associated cost, to guide the search for the new data point 402. The trial data point 402 is then fed into the full motion planner 202, which is preferably a static trajectory simulator, i.e., a simulator which generates a set of trajectory decisions for each of a set of discrete points along the path of a predetermined journey.

In some embodiments, the motion planner may also contain a trajectory sampler, which is used to determine multiple potential trajectories the ADV may take. The sampler uses, e.g., some knowledge of the road, static object interaction, car dynamics, and modelling dynamics of other moving objects, and the like. Then, the motion planner uses the hyperparameters (i.e., 402, xᵢ₊₁) provided to it to select which trajectory should be taken that will minimise the trajectory cost.

The motion planner 202 generates a set of decisions 404 related to at least one predetermined journey. In the illustrated example, [symbol] I₁, . . . I_{T} [symbol] represents a set of lateral decisions, and [symbol] S₁, . . . S_{T}= represent a set of speed decisions. The result of these decisions is then fed into the cost function 406 which compares the trial motion planner output 404 against human-labelled data, to calculate the cost f(xᵢ₊₁) associated with the trial data.

As mentioned, the solver 304 can take a plurality of different forms, e.g., such as Bayesian optimisation and/or generic algorithms, to generate new search point 402 that are predicted to produce improved motion planner decisions. Preferably, the motion planner 202 utilises more than one predetermined journey, such that a plurality of sets of decisions 404 are created with which to generate a cost. In this way, the solver is more likely to produce improved trial hyperparameters that are generalisable to unknown driving locations, i.e., such that they are not ‘overfit’ to one particular type of journey or location.

### Bayesian Optimisation

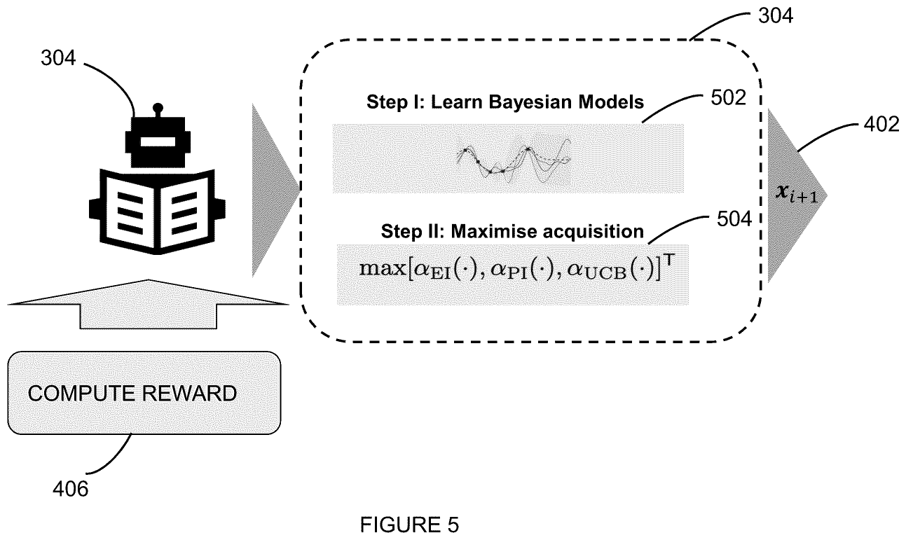

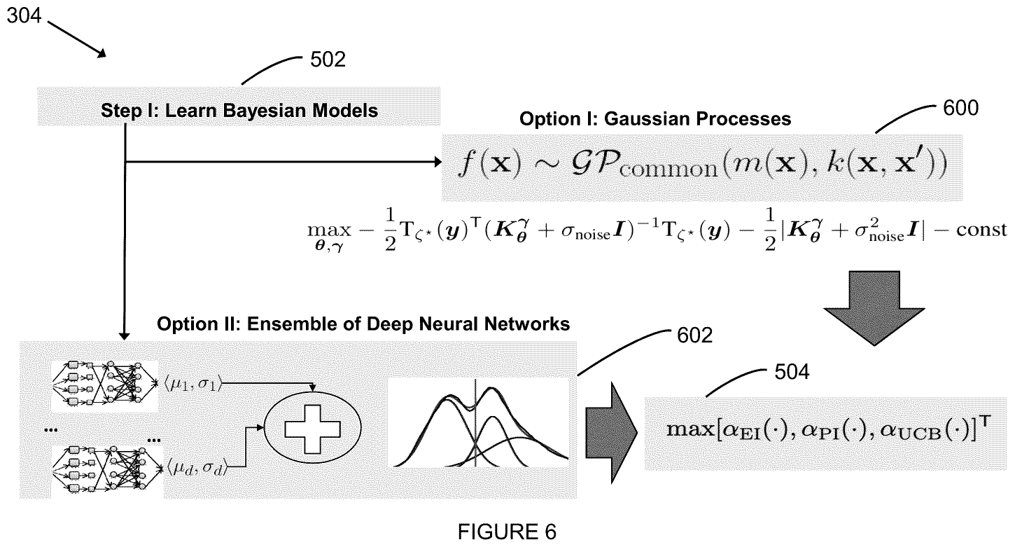

FIG. 5 illustrates an embodiment of the solver 304 of the process 400 which uses Bayesian optimisation to generate new trial data points 402. The general approach of a Bayesian optimisation routine is to statistically model some function deemed to be a ‘black box’, i.e., whose analytical form is not known, and/or which is prohibitively expensive to sample directly. In this case, the motion planner represents the black box. The modelling approach can be split into two broad stages:
I. Learning the model 502. A function known as a surrogate function is used as a substitute to the black box motion planner 202. The objective of the surrogate model is to model the relationship between the data pairs, [symbol] xᵢ, f(xᵢ) [symbol] , such that new data points can be predicted. The surrogate function is therefore sampled in place of the costly black box function. Various options exist for the form of the surrogate function, which would be apparent to the skilled person. Two example forms are described below with reference to FIG. 6.
II. Maximise an acquisition of the function 504. Once the form of the surrogate function has been established, the output range of the function is explored to find an ‘optimal’ input value. An acquisition function is used to explore the space of the surrogate function to find the input, xᵢ, which maximises the output value (or minimises the cost, depending on what the surrogate function models) of the surrogate function. Thus, the acquisition function can be seen as the guidance objective of a solver 304 that uses Bayesian optimisation.

There are a large number of acquisition functions 504 that can be used, alone or in combination, to implement an acquisition function. Preferably, the acquisition function contains an ‘expected improvement’ function, denoted α_{EI}. Notionally, when attempting to minimise/maximise a function, the expected improvement provides a reward that is proportional to the improvement over the current maximum/minimum value.

Multiple acquisition functions 504 can be used in combination. In the illustrated example, three functions are used: expected utility, probability of improvement, and upper confidence bound, the latter two denoted α_{PI} and α_{UCB}.

Definitions of the above acquisition functions are as follows, assuming minimisation off(x), where f′ represents the lowest known value of f(x):

Probability of improvement:

$$u ( x ) = \{ \begin{matrix}0 , & f ( x ) > {f}^{′} \\ 1 , & f ( x ) \leq {f}^{′}\end{matrix}$$

Expected improvement:

$$u ( x ) = max ( 0 , {f}^{′} - f ( x ) )$$

The above acquisition functions 504 are thus the expected utility as a function of x, e.g.:

A_{EI}= [symbol] [u(x)|x, [symbol] ], where [symbol] represents the current set of observations, also called priors, i.e., the set of [symbol] xᵢ, f(xᵢ) [symbol] .

Upper confidence bound is defined as: α_{UCB}(x, β)=μ(x)−βσ(x), where μ(x) and σ(x) are mean and variance, respectively, and β is a parameter used to control the degree of exploration. Other acquisition functions are also known in the art and would be suitable for use either alone or in combination with the above functions. For example, other acquisition functions 504 include simple regret (SR), entropy search (ER), and knowledge gradient (KG).

Once a new search point 402, xᵢ₊₁, has been determined by the acquisition function, it is fed into the motion planner 202 and subsequently the reward function 406 in order to quantify the quality of the new data point. In the context of Bayesian optimisation, the new value, f(xᵢ₊₁), of the surrogate function is referred to a posterior data point. The new posterior data, [symbol] xᵢ₊₁, f(xᵢ₊₁) [symbol] , is then used to update the prior data.

Generally speaking, the acquisition model is designed to take both the predicted objective value and the uncertainty around that predicted objective value into consideration when scoring hyperparameter sets. An objective of the acquisition function 504 is to locate either a minimum or maximum the surrogate function. To search effectively for this region, it is advantageous for acquisition functions to be designed to search beyond local minima or maxima. This type of searching, i.e., evaluating points with higher predicted uncertainty in order to avoid getting stuck at local minima/maxima, is referred to as exploration. On the other hand, acquisition functions should preferably be tuneable such that an appropriate weighting is given to evaluations that return optimal (i.e., maximum, or minimum) values. Searching in the region nearby optimal values is referred to as exploitation, e.g., evaluation points with low mean.

Therefore, it is beneficial for an acquisition to be designed with an effective trade-off between exploration and exploitation. Various methods for implementing acquisitions functions such that this trade-off can be tuned will be apparent to the skilled person. For example, with α_{UCB}, μ(x) can be considered an exploitation term, and σ(x) an exploration term, controlled by exploration parameter β. Further advantageously, the expected improvement function inherently captures both exploration and exploitation considerations.

In preferable embodiments, an acquisition function 504 used in the present disclosure is constructed as

$${max [ {α}_{EI} ( \cdot ) , {α}_{PI} ( \cdot ) , {α}_{U C B} ( \cdot ) ]}^{T}$$

The choice of whether to maximise or minimise a surrogate function depends on the formulation of the surrogate function: e.g., whether the output of a surrogate function represents a reward (to be maximised), or a cost (to be minimised).

Further, there is a large scope for different methods of seeking a minimum/maximum value once the metrics of the optimisation have been defined using by the acquisition function. In other words, once an acquisition function has been determined, the search for new points is guided by a search function. For example, gradient based methods known in the art can be applied to determine local maxima or minima in the surrogate function, guided by the acquisition function. Furthermore, the type of function used to guide the search is readily tradeable/interchangeable.

FIG. 6 illustrates two alternative methods of constructing a surrogate function 502 for use in a Bayesian optimisation solver 304.

In one alternative, the surrogate function models the motion planner 202 using a Gaussian process 600. Use of Gaussian processes in Bayesian optimisation schemes is known in the art. The real ‘black box’ function, f(x), is modelled as:

$$p ( f ) = 𝒢𝒫 ( μ ( x ) , k ( x , {x}^{′} ) )$$

which is conditioned on the set of priors, [symbol] = [symbol] xᵢ, f(xᵢ) [symbol] , such that

$$p ( f \vert 𝒟 ) = 𝒢𝒫 ( {μ ( x )}_{f \vert 𝒟} , {k ( x , {x}^{′} )}_{f \vert 𝒟} )$$

where μ(x) represents the mean, and k(x, x′) represents the variance.

In order to find Gaussian process parameters that fit current observations, and equation referred to as the marginal likelihood is maximised. The use and application of this equation is not described in further detail as it is within the remit of the skilled person to implement this equation as part of a Gaussian Process. The marginal likelihood is defined as follows:

$${max}_{θ , γ} - \frac{1}{2} {T}_{ζ} \cdot {( y )}^{⊤} {( {K}_{θ}^{γ} + {σ}_{noise} I )}^{- 1} {T}_{ζ} \cdot ( y ) - \frac{1}{2} \vert {K}_{θ}^{γ} + {σ}_{noise}^{2} I \vert - const$$

The Gaussian process (GP) model is sampled using an acquisition function to provide a prediction as to a new input value 402 that will maximise (or, in the case where the surrogate function models a cost, minimise) the value of the GP. Any suitable acquisition function as described above would be appropriate.

An advantage of using a GP as a surrogate function is that it is possible to quantify the predictive uncertainty at any given point, e.g., such that the likely value of unknown search points can be evaluated. The GP will, initially, produce inaccurate results due to a small initial data set [symbol] . However, after each iteration produces a new trial set of hyperparameters,xᵢ, which is then used to query the real model being simulated (the motion planner 202), the model matures as the Bayesian optimisation progresses and produces increasingly more valuable outputs (e.g., a valuable set of hyperparameters cause the motion planner to output more accurate results than currently deployed models).

A second alternative surrogate function indicated in FIG. 6 is an ensemble of neural networks 602, e.g., deep neural networks. In this method, a plurality of neural networks is independently initialised and independently trained to model the data, [symbol] . These neural networks are combined to create a Gaussian mixture model (GMM), where the predictive posterior of the GMM is sampled using an acquisition function to determine new search points.

The inventors have identified that, in some cases, a GP surrogate model can produce complex and/or noisy functions that are difficult to optimise using acquisition functions. Therefore, the GMM formed from an ensemble of neural networks may be used in the most difficult cases, i.e., to estimate the predictive uncertainty of new search points. The GMM using a neural network ensemble is more time-consuming in general than a GP model, therefore there is a trade-off between efficiency and accuracy when choosing between the GP model and the GMM of neural networks. Any number of neural networks can be combined in principle; however, the inventors have identified that more than 10, or around 15, neural networks produce good results.

Furthermore, the type of surrogate function can be interchanged during the course of a Bayesian optimisation process. For example, the process may be initialised over a preliminary number of iterations using one surrogate function, and continue using a different surrogate function (not shown in FIG. 6).

It is noted that the ensemble of neural networks has the potential to produce more accurate results than the GP surrogate function, however, the neural networks are most effective when initialised using a larger data set, [symbol] . Therefore, in some embodiments, the more efficient GP model 600 may be used initially to build a set of priors (e.g., where the data initially contains only one data pair, [symbol] x₁, f(x₁) [symbol] ), after which the GMM 602 is fitted to the data produced using the GP, and continues iterating the Bayesian optimisation process. For example, the GMM may continue the optimisation process 400 once the data [symbol] contains enough data pairs from which to initialise the set of neural networks. Merely for example, 1000 data points may be obtained using a Gaussian Process surrogate, a GMM surrogate model (built using an ensemble of neural networks) is used for the remainder of the Bayesian Optimisation process to further refine the result. In general, it can be advantageous to swap from a GP to a GMM surrogate function when the dataset becomes large, because GMMs work most effectively when given a large dataset and, moreover, GMMs can produce more accurate results than a GP model given a large dataset.

Alternatively, if the GP model begins to struggle producing improved hyperparameters (e.g., because the function is too noisy or complex), the GMM may take over.

The following equations are used when using an ensemble of neural networks to form a GMM, in which theta, θ, represents the set of hyperparameters:

$$p ( y \vert θ ) = {M}^{- 1} {\sum }_{m = 1}^{M} p {θ}_{m} ( y \vert x , {θ}_{m} ) \qquad 1 )$$

$$p ( y \vert x , {θ}_{m} ) = 𝒩 ( y \vert {μ}_{*} ( x ) , {σ}_{*} ( x ) ) \qquad 2 )$$

$${μ}_{*} ( x ) = {M}^{- 1} {\sum }_{m} μ {θ}_{m} ( x ) \qquad 3 )$$

$${σ}_{*} ( x ) = {M}^{- 1} {\sum }_{m} ( {σ}_{{θ}_{m}}^{2} ( x ) + {μ}_{{θ}_{m}}^{2} ( x ) ) - {μ}_{*} ( x ) \qquad 4 )$$

The above equations describe the following:
1) Probability of y is equal to the average probability of y given each mixture in the GMM.
2) Probability of y is equal to the normal distributed by the average of each mixture's mean and the combined variance of each mixture.
3) Used for calculating the approximate centre of the GMM.
4) Used for calculating the approximate variance of the centre of the GMM

### Evolutionary Algorithm

As mentioned above, the solver/agent 304 used as part of the optimisation process can take many forms, and in some cases the sample may query the motion planner directly. This is appropriate in cases, for example, where the computational cost of running the motion planner is not too high. In one embodiment, an evolutionary algorithm or genetic algorithm, may be used to sample the motion planner directly. However, the functional form of the motion planner does not need to be known for this purpose, and can be treated as a black box.

Alternatively, in examples where the computational cost of the motion planner is still too high to sample it directly, a surrogate function can be used to model the motion planner in the manner as described above for Bayesian optimisation, and an evolutionary algorithm can be employed to optimise the acquisition function (i.e., instead of using a gradient-based method). When an evolutionary algorithm is employed to optimise the acquisition function, the ‘fitness’ can be calculated directly using the motion planner 202.

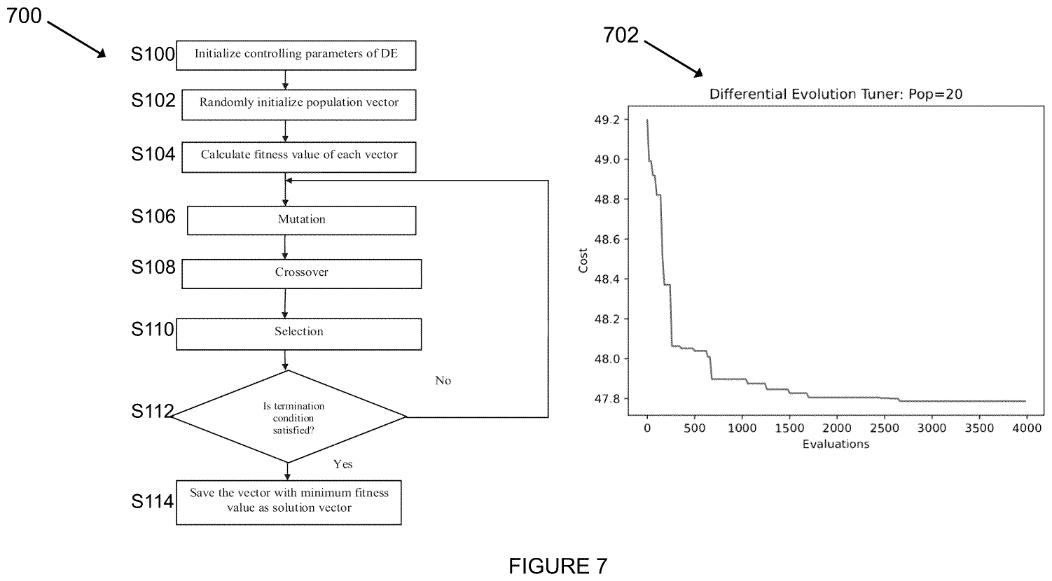

FIG. 7 shows a general scheme for an evolutionary algorithm 700, in which:

At step S100, control parameters for the evolutionary algorithm are initialised. In this example, the algorithm is differential evolution (DE) algorithm.

S102 comprises randomly initiating a population vector. For example, a random set of hyperparameters are chosen from which to seed start of the algorithm in the search for improved hyperparameters. Alternatively, where a ‘good’ set of hyperparameters are already known (i.e., currently deployed hyperparameters that are known to perform will), this set may be used to spawn an initial set of population vectors. Preferably a large number of population vectors are typically initialised, e.g., at least 50 or 100.

At S104, the fitness value of each vector is calculated, i.e., using a suitable objective function such as a cost or reward function. For the avoidance of doubt, generally in this example the calculation of the reward requires directly running the motion planner. In other examples, an approximation to the cost function described above may be employed, i.e., such that the computationally expensive motion planner 202 does not have to be run.

S106, S108, and S110 comprise the steps of mutation, crossover, and selection, respectively. In general, the objective after each iteration is to keep the best performing set of parameters and remove the worst set of parameters, such that the mutation step spawns new parameters only from high-performing sets of parameters. Preferably, elitism is employed such that high-performing sets of hyperparameters are inserted into the next generation without undergoing mutation, which can provide advantageous convergence of the genetic algorithm.

At S112, it is determined whether a termination condition has been satisfied. If not, steps S106, S108, and S110 are repeated until the termination condition is satisfied. The condition may be met when, for example, the algorithm produces a solution that outperforms the current-best (i.e., currently deployed) hyperparameters, or when the performance of a new hyperparameters is no longer improving.

Once steps S106, S108, and S110 terminate, at S114, the vector having the minimum cost (which is notionally equivalent to the maximum fitness value) is selected as the solution.

The skilled person will appreciate that many variations of genetic algorithms exist, and it would be within the remit of the skilled person to select an appropriate variant for use in the current disclosure.

As described above, preferably, the objective function that scores (e.g., calculates either a cost or reward) a given set of hyperparameters uses journey data from a plurality of different locations/journeys to calculate the score. Advantageously, this helps to produce generalisable hyperparameters that can perform well irrespective of road conditions, city, road type, etc.

Graph 702 shows the results of running a DE evolutionary algorithm for a number of evaluation iterations. It can be seen that, with an initial population of 20, the cost of optimised hyperparameters sets can be reduced and optimised over e.g., 4000 evaluation steps. Graph 702 was produced as a result of running the DE algorithm on a dynamic simulator (Kybersim) rather than a static simulator.

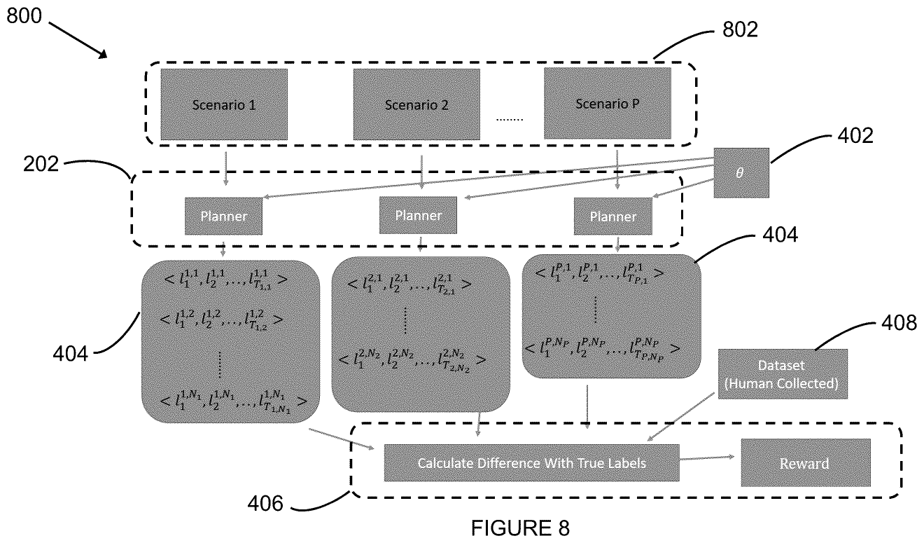

FIG. 8 shows how journey data from multiple different scenarios can be combined 800 into a single score for a single set of hyperparameters, θ. The hyperparameters 402 (θ, or xᵢ) used to operate the motion planner can be generated or obtained by any method suitable method, including all those of the present disclosure.

The multiple different scenarios represent different journeys taken by a vehicle, preferably real journeys that provide real traffic and driving conditions. The data from each journey is processed separately by a motion planner 202, where the trajectories for each scenario are determined based on the same set of generated hyperparameters 402. In this scenario, the motion planner is preferably a static simulator. For each journey, the motion planner outputs a set of decisions 404 for each point in the static simulation. Although only lateral planning decisions are indicated in FIG. 6, any number of different vehicle motion decision types, relating to different types of vehicle action or motion, can be output.

The collective set of decisions from all scenarios 802 are then compared against the human-labelled truth data 408, for example using the Cost(θ) function defined above, in order to score 406 the hyperparameters 402. Advantageously, the accuracy of decisions relating to an arbitrary number of different journeys can be quantified and combined into a single objective (cost) value, for a given set of hyperparameters.

In some embodiments, all journey data available may be used to calculate the Cost(θ) in order to guide the building of a surrogate model and/or progress of a genetic algorithm. However, in other embodiments, it can be advantageous to operate the hyperparameters improvement process 400 using only a subset of the journey data 802, and save the remaining data for cross-validation purposes. This can be beneficial for validating that the process 400 is not conditioned to overfit data, i.e., is capable of generating new hyperparameters that generalise well to new environments.

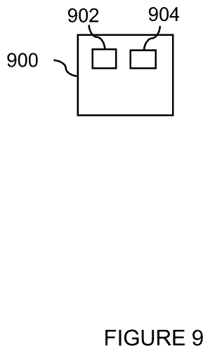

FIG. 9 illustrates an example of an apparatus 900 configured to implement any of the methods described herein. The apparatus 900 may be implemented on an electronic device, such as a laptop, tablet, smart phone, other mobile electronic device, or TV.

The apparatus 900 comprises a processor 902 configured to process the datasets in the manner described herein. For example, the processor 902 may be implemented as a computer program running on a programmable device such as a Central Processing Unit (CPU). The apparatus 900 comprises a memory 904 which is arranged to communicate with the processor 902. Memory 904 may be a non-volatile memory (e.g., permanent storage). The processor 902 may also comprise a cache (not shown in FIG. 9), which may be used to temporarily store data from storage 904. The apparatus 900 may comprise more than one processor 902 and more than one storage 904. The storage 904 may store data that is executable by the processor 902. The processor 902 may be configured to operate in accordance with a computer program stored in non-transitory form on a machine-readable storage medium. The computer program may store instructions for causing the processor 902 to perform its methods in the manner described herein.

The processor may be implemented as fixed-logic circuitry, e.g., as an FPGA (field-programmable gate array) or ASIC (Application-specific integrated circuit) device. Furthermore, the apparatus may comprise a plurality of processors configured to run in parallel. It would be within the remit of the skilled person to implement at least a portion of the methods of the present disclosure such that they can be carried out in parallel, for example, the calculation of a plurality of outcomes and utility scores for a plurality of predetermined journeys can be readily parallelized.

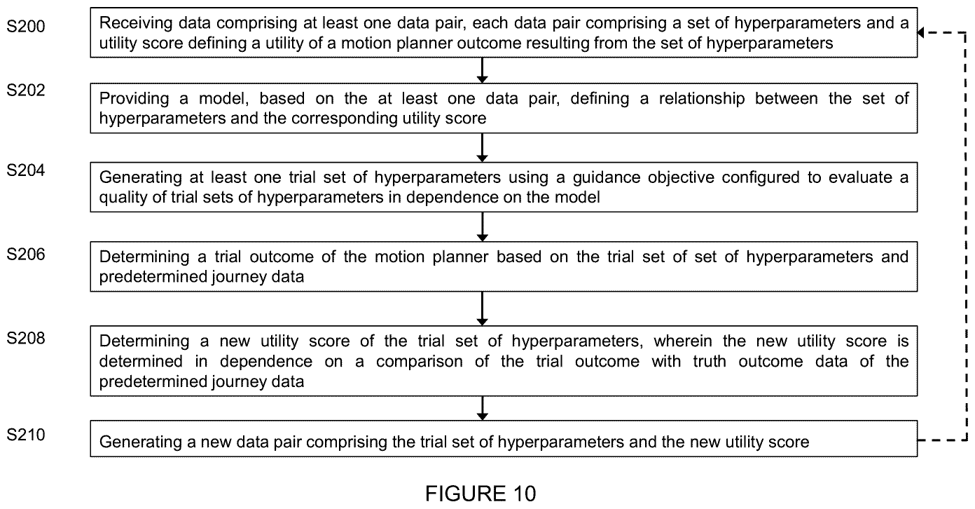

Specifically, the disclosed hyperparameters improvement apparatus may comprise one or more processors, such as processor 902, and a memory 904 storing in non-transient form data defining program code executable by the processor(s) to implement a hyperparameter improvement apparatus model, such as the method steps of FIG. 10.

FIG. 10 summarises an example of a method 900 for providing roved hyperparameters for use in an autonomous vehicle motion planner. S200 comprises receiving data comprising at least one data pair, each data pair comprising a set of hyperparameters and a utility score defining a utility of a motion planner outcome resulting from the set of hyperparameters. S202 comprises providing a model, based on the at least one data pair, defining a relationship between the set of hyperparameters and the corresponding utility score. S204 comprises generating at least one trial set of hyperparameters using a guidance objective configured to evaluate a quality of trial sets of hyperparameters in dependence on the model. S206 comprises determining a trial outcome of the motion planner based on the trial set of set of hyperparameters and predetermined journey data. S208 comprises determining a new utility score of the trial set of hyperparameters, wherein the new utility score is determined in dependence on a comparison of the trial outcome with truth outcome data of the predetermined journey data, and S210 comprises generating a new data pair comprising the trial set of hyperparameters and the new utility score.

In preferable examples, the method iterates such that the generated data pair in S210 is added to the receive data, which is then used as the input in S200.

As described above, preferably the motion planner 202 is a static simulator, since dynamic driving simulators are often prohibitively computationally expensive to run and would therefore slow the progress of a Bayesian optimisation algorithm. However, improved hyperparameters produced as part of the methods describes above can be further validated, e.g., in addition to cross-validation using the static simulator mentioned above.

A dynamic simulator may be used to validate hyperparameters produced using the presently disclosed methods. This can be advantageous for assigning a more accurate score to hyperparameter sets, and/or for ensuring that a set of hyperparameters will produce safe results when deployed in the real world.

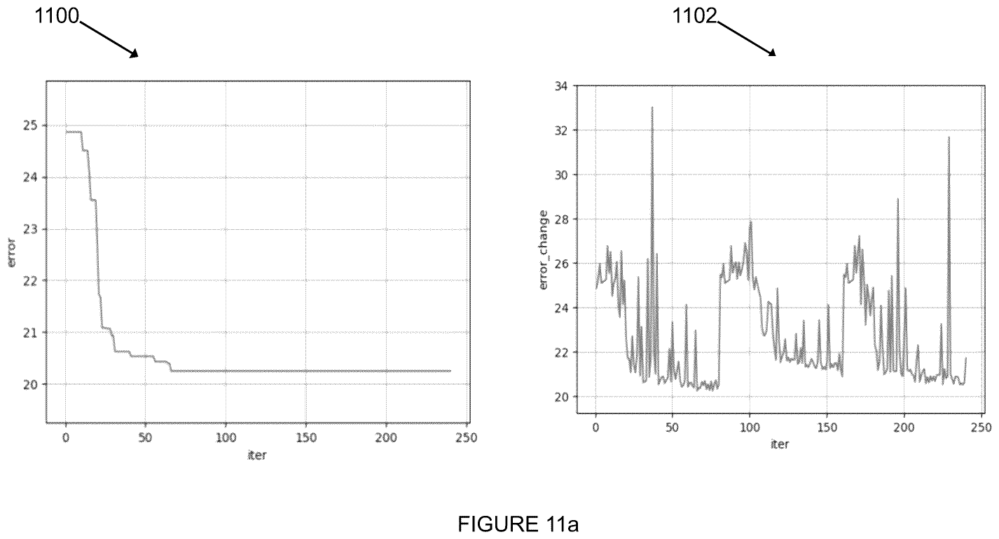

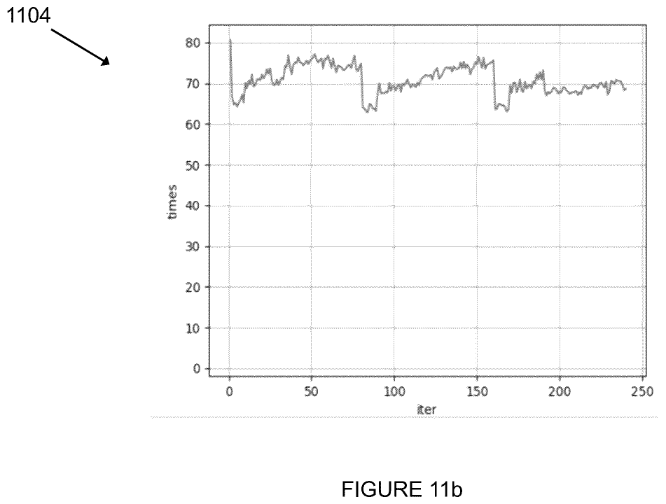

FIGS. 11a and 11b show the results of such a dynamic simulation. In this example, Kybersim is used to evaluate hyperparameters by simulating different driving locations. Using dynamic simulators such as Kybersim provides the benefit that an even more realistic (e.g., real-world) performance of the selected ADV parameters can be estimated.

Kybersim is a known industrial simulator for autonomous vehicles. The chosen ‘best’ set of hyperparameters output by one of the embodiments described above is used as input. Given the set of parameters, the dynamic simulator operates such that objects can interact with the vehicle, e.g., such as other (moving) vehicles or pedestrians. Thus, one can have a better idea of how the parameters chosen by the agent (solver 304) will respond when deployed in the real world.

1100 and 1102 show, respectively, the error and change in error of a progressing Kybersim simulation after a number of iterations. 1104 shows the improving journey time of journeys simulated by Kybersim after a number of iterations.

By the employing the Kybersim simulator as shown and the results of the hyperparameters optimisation methods described herein, the inventors were able to obtain a 60% relative improvement in speed across the scenarios.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present disclosure may consist of any such individual feature or combination of features. In view of the foregoing description, it will be evident to a person skilled in the art that various modifications may be made within the scope of the disclosure and claims.

1. An apparatus for determining improved hyperparameters for use in an autonomous vehicle motion planner, the apparatus comprising:
one or more processors; and
a memory storing data in non-transient form defining a program code executable by the one or more processors, wherein the one or more processors execute the program code to cause the apparatus to:
receive data comprising at least one data pair, each data pair comprising a set of hyperparameters and a utility score defining a corresponding utility of a motion planner outcome resulting from the set of hyperparameters;
provide a model, based on the at least one data pair, wherein the model defines a relationship between the set of hyperparameters and the corresponding utility score;
generate at least one trial set of hyperparameters using a guidance objective configured to evaluate a quality of trial sets of hyperparameters in dependence on the model;
determine a trial outcome of the motion planner in dependence on the trial set of hyperparameters and predetermined journey data;
determine a new utility score of the trial set of hyperparameters, wherein the new utility score is determined in dependence on a comparison of the trial outcome with truth outcome data associated with the predetermined journey data; and
generate a new data pair comprising the trial set of hyperparameters and the new utility score.

2. The apparatus of claim 1, wherein the model is a probabilistic surrogate function, and wherein the guidance objective is configured to generate the at least one trial set of hyperparameters by:
fitting the probabilistic surrogate function to one or more of the at least one data pair; and
searching a domain space of hyperparameter inputs in dependence on sampling the probabilistic surrogate function.

3. The apparatus of claim 2, wherein the probabilistic surrogate function is a gaussian process model.

4. The apparatus of claim 2, wherein the probabilistic surrogate function is a gaussian mixture model formed from the combination of a plurality of neural networks.

5. The apparatus of claim 2, wherein the search of the domain space of hyperparameter inputs is guided by an acquisition function configured to determine the quality of trial sets of hyperparameters based at least in part on a predicted uncertainty of a value of the surrogate function resulting from a trial set of hyperparameters.

6. The apparatus of claim 5, wherein the acquisition function comprises one or more of the following functions: an expected utility function, a probability of improvement function, and an upper confidence bound function.

7. The apparatus of claim 2, wherein the search of the domain space of hyperparameter inputs is guided by an evolutionary algorithm.

8. The apparatus of claim 1, wherein the model is the motion planner, and the guidance objective is configured to generate the at least one trial set of hyperparameters using an evolutionary algorithm to stochastically determine new data pairs in dependence on evaluating a utility score of one or more new sets of hyperparameters.

9. The apparatus of claim 1, wherein the trial outcome is a vehicle trajectory comprising a plurality of vehicle motion decisions corresponding to at least one type of vehicle motion action.

10. The apparatus of claim 1, wherein the corresponding utility score represents the accuracy of a trial outcome compared to the truth outcome data, the truth outcome data comprising human-labelled vehicle motion decisions.

11. The apparatus of claim 10, wherein the corresponding utility score is determined in dependence on an objective function which rewards correct decisions in the trial outcome and/or penalises decisions in the trial outcome which are incorrect and have previously been determined as correct based on an initial set of hyperparameter inputs in the received data.

12. The apparatus of claim 1, wherein the predetermined journey data comprises a plurality of journeys, and the one or more processors further execute the program code to cause the apparatus to:
determine a plurality of trial outcomes, one per journey, using the trial set of hyperparameters; and
determine the corresponding utility score based on the plurality of trial outcomes.

13. The apparatus of claim 1, wherein the one or more processors further execute the program code to cause the apparatus to: determine the trial outcome of the motion planner using a static simulator.

14. The apparatus of claim 1, wherein the one or more processors further execute the program code to cause the apparatus to: repeatedly perform the following processes:
generating at least one trial set of hyperparameters;
determining a new utility score; and,
wherein the received data comprises a previously generated new data pair.

15. A method for determining improved hyperparameters for use in an autonomous vehicle motion planner, the method which applied to an electronic apparatus comprising:
receiving data comprising at least one data pair, each data pair comprising a set of hyperparameters and a corresponding utility score defining a utility of a motion planner outcome resulting from the set of hyperparameters;
providing a model, based on the at least one data pair, wherein the model defines a relationship between the set of hyperparameters and the corresponding utility score;
generating at least one trial set of hyperparameters using a guidance objective configured to evaluate a quality of trial sets of hyperparameters in dependence on the model;
determining a trial outcome of the motion planner based on the trial set of set of hyperparameters and predetermined journey data;
determining a new utility score of the trial set of hyperparameters, wherein the new utility score is determined in dependence on a comparison of the trial outcome with truth outcome data of the predetermined journey data; and
generating a new data pair comprising the trial set of hyperparameters and the new utility score.

16. The method of claim 15, wherein the model is a probabilistic surrogate function, and wherein the guidance objective is configured to generate the at least one trial set of hyperparameters by:
fitting the probabilistic surrogate function to one or more of the at least one data pair; and
searching a domain space of hyperparameter inputs in dependence on sampling the probabilistic surrogate function.

17. The method of claim 16, wherein the probabilistic surrogate function is a gaussian process model.

18. The method of claim 16, wherein the probabilistic surrogate function is a gaussian mixture model formed from the combination of a plurality of neural networks.

19. The method of claim 16, wherein the search of the domain space of hyperparameter inputs is guided by an acquisition function configured to determine the quality of trial sets of hyperparameters based at least in part on a predicted uncertainty of a value of the surrogate function resulting from a trial set of hyperparameters.

20. The method of claim 19. wherein the acquisition function comprises one or more of the following functions: an expected utility function, a probability of improvement function, and an upper confidence bound function.
